(19) United States
(12) Patent Application Publication
(10) Pub. No.: US 2026/0312694 A1
(43) Pub. Date: Oct. 8, 2026

(54) DIFFERENTIAL PHASE SHIFT KEYING DEMODULATOR

(71) Applicant: BAE Systems Information and Electronic Systems Integration Inc., Nashua, NH (US)

(72) Inventors: Peter Ladubec, JR., Centereach, NY (US); Richard J. Lavery, Huntington, NY (US)

(73) Assignee: BAE Systems Information and Electronic Systems Integration Inc., Nashua, NH (US)

(21) Appl. No.: 19/171,448

(22) Filed: Apr. 7, 2025

(51) Int. Cl. H04B 10/67; H04L 27/38

(52) U.S. Cl. CPC H04B 10/677; H04L 27/3854

(57) ABSTRACT

Demodulation of differential phase shift keying (DPSK) signals. A system implementing the techniques according to an embodiment includes a magnitude/phase calculator configured to convert in-phase and quadrature phase components of a signal to magnitude and phase samples. The system also includes a preamble detector configured to detect a preamble in the signal based on the magnitude samples. The system further includes a synchronization phase reversal (SPR) detector configured to detect an SPR in the signal to generate a demodulation timing gate. The detection of the SPR is based on the phase samples and on an SPR time offset relative to the detected preamble. The system further includes a phase correction circuit configured to compensate for phase wrapping of the phase samples to generate corrected phase samples, and a DPSK demodulator configured to integrate the corrected phase samples over integration periods, based on the demodulation timing gate, to demodulate the signal.

### STATEMENT OF GOVERNMENT INTEREST

This invention was made with United States Government assistance under Contract Nos. FA8232-17-D-0027 and FA8232-21-F-0286. The United States Government has certain rights in this invention.

### FIELD OF DISCLOSURE

The present disclosure relates to signal processing, and more particularly to improved demodulation of differential phase shift keying (DPSK) signals.

### BACKGROUND

Digital radio frequency (RF) receivers typically down convert RF signals to baseband signals, generating in-phase (I) and quadrature (Q) samples at a baseband rate. Some types of signals use DPSK modulation in which the data bits are encoded as phase changes. These signals may then be decoded using DPSK demodulation of the baseband signals by detecting phase changes in the IQ sample stream. Coarse estimates of the phase may be used for computational efficiency, for example based on the sign bits of the IQ samples, but this can cause errors in the presence of noise and interference, which can adversely affect demodulation.

### BRIEF DESCRIPTION OF THE DRAWINGS

FIG. 1 illustrates a receiver system, in accordance with certain embodiments of the present disclosure.

FIG. 2 is a block diagram of the demodulation system of FIG. 1, configured in accordance with certain embodiments of the present disclosure.

FIG. 3A illustrates phase overflow, in accordance with certain embodiments of the present disclosure.

FIG. 3B illustrates phase correction, in accordance with certain embodiments of the present disclosure.

FIG. 4 is a block diagram of the synchronization phase reversal (SPR) detector of the demodulation system of FIG. 2, configured in accordance with certain embodiments of the present disclosure.

FIG. 5 is a block diagram of the phase corrector of the demodulation system of FIG. 2, configured in accordance with certain embodiments of the present disclosure.

FIG. 6 is a block diagram of the DPSK demodulator of the demodulation system of FIG. 2, configured in accordance with certain embodiments of the present disclosure.

FIG. 7 is a flowchart illustrating a methodology for demodulation of DPSK signals, in accordance with an embodiment of the present disclosure.

FIG. 8 is a block diagram of a processing platform configured to perform DPSK signal demodulation, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for demodulation of differential phase shift keying (DPSK) signals. As noted above, digital RF receivers typically down convert RF signals to baseband signals, generating in-phase (I) and quadrature (Q) samples at a baseband rate. Some signals of interest use DPSK modulation in which the data bits are encoded as phase changes. These signals may be decoded through DPSK demodulation of the baseband signals by detecting phase changes in the IQ sample stream (e.g., phase changes of 180 degrees or pi radians). Coarse estimates of the phase may be used for computational efficiency, for example based on the sign bits of the IQ samples, but this can cause errors in the presence of noise and interference, which can adversely affect demodulation and system performance. Although additional bits of the IQ samples may be used to compute the phase from the IQ samples, by various methods, problems can still arise due to phase wrap or overflow.

To this end, and in accordance with an embodiment of the present disclosure, a DPSK demodulation system is provided which uses high resolution (e.g., 16 bit) IQ samples generated by a digital receiver configured to perform direct RF sampling and digital down conversion. The DPSK demodulation system is configured to perform phase correction, integration, and thresholding to provide improved demodulation error rates in the presence of noise and interference, which allows for operation in a lower signal to noise ratio environment. In some embodiments, the DPSK demodulation system is an Identification Friend or Foe (IFF) Mode Select (Mode S) interrogation demodulator.

In accordance with an embodiment, a system implementing the techniques for DPSK demodulation includes a magnitude/phase calculator configured to convert in-phase and quadrature phase components of a signal to magnitude and phase samples. The system also includes a preamble detector configured to detect a preamble in the signal based on the magnitude samples. The system further includes a synchronization phase reversal (SPR) detector configured to detect an SPR in the signal to generate a demodulation timing gate. The detection of the SPR is based on the phase samples and on an SPR time offset relative to the detected preamble. The system further includes a phase correction circuit configured to compensate for phase wrapping of the phase samples to generate corrected phase samples, and a DPSK demodulator configured to integrate the corrected phase samples over integration periods, based on the demodulation timing gate, to demodulate the signal. In some embodiments, the SPR may be associated with an IFF Mode S signal.

It will be appreciated that the techniques described herein may provide improved DPSK demodulation, compared to other methods that use coarser phase estimates and do not correct for phase overflow. Numerous embodiments and applications will be apparent in light of this disclosure.

### System Architecture

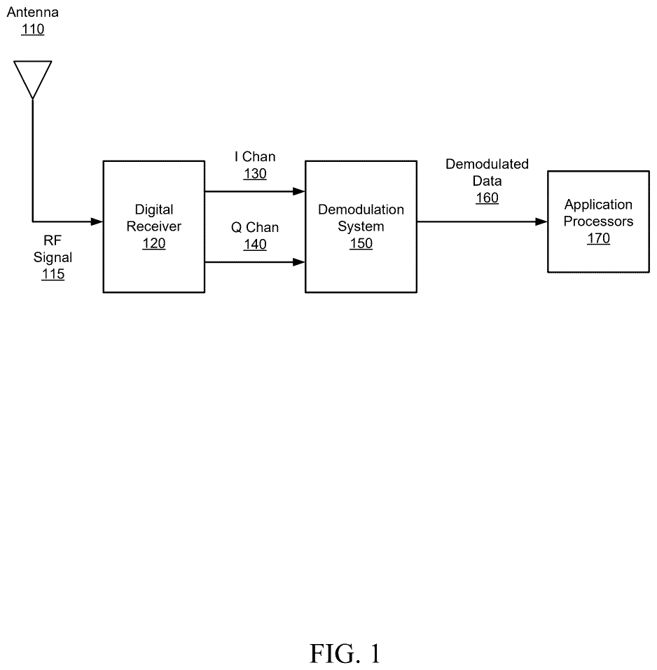

FIG. 1 illustrates a receiver system 100, in accordance with certain embodiments of the present disclosure. The receiver system 100 is shown to include an antenna 110, a digital receiver 120, a demodulation system 150, and application processors 170. Other examples may be configured differently and/or with different levels of integration, but still carry out similar functionality. For instance, in another example, demodulation system 150 may be integrated or otherwise a part of digital receiver 120. Likewise, application processors 170 may be integrated or otherwise a part of demodulation system 150.

The antenna 110 is configured to receive RF signals 115 from any number of sources and provide them to the digital receiver 120. The RF signals 115 may include DPSK modulated communication signals. In some embodiments, the RF signal 115 may transmitted from an aircraft IFF system operating in Mode S.

The digital receiver 120 is configured to frequency down-convert the RF signal to a baseband signal, at a baseband sampling rate, comprising an in-phase (I) component and a quadrature phase (Q) component. Samples of the I component 130 are provided to the demodulation system on an I channel, and samples of the Q component 140 are provided to the demodulation system on a Q channel. In some embodiments, the samples may be of relatively high precision, for example 16 bits or more. In some embodiments, the digital receiver may include filters, amplifiers, analog to digital converters, and the like, to perform direct RF sampling and digital down conversion.

The demodulation system 150 is configured to perform DPSK demodulation of the baseband signal I samples 130 and Q samples 140 using the techniques disclosed herein to provide improved demodulation with reduced error rates, as described in greater detail below.

The application processors 170 are configured to perform application specific tasks based on the demodulated signal data 160. For example, in some embodiments, in which the signal is an IFF Mode S signal, the demodulated data 160 may be used to identify the aircraft that is the source of the transmission as well as to provide additional data for situational awareness such as aircraft position, altitude, and velocity.

Although the demodulation system as described herein is directed to demodulation of an IFF Mode S signal, the techniques can be applied more generally to other DPSK modulated waveforms that provide a timing reference (e.g., in a message preamble) for the data embedded in the waveform.

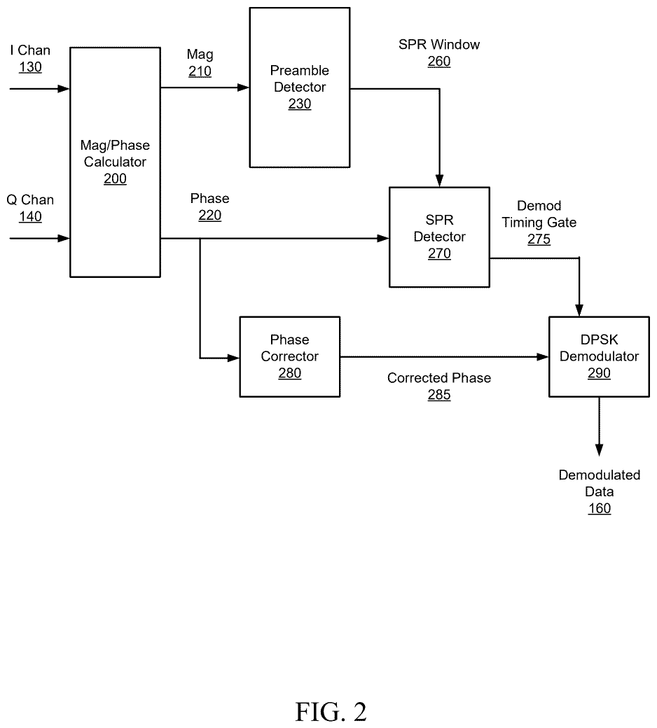

FIG. 2 is a block diagram of the demodulation system 150 of FIG. 1, configured in accordance with certain embodiments of the present disclosure. The demodulation system 150 is shown to include a magnitude/phase calculator 200, a preamble detector 230, an SPR detector 270, a phase corrector 280, and a DSPK demodulator 290.

The magnitude/phase calculator 200 is configured to convert the I component samples 130 of the baseband signal and the Q component samples 140 of the baseband signal to magnitude samples 210 and phase samples 220. In some embodiments, the magnitude/phase calculator 200 is implemented as a coordinate rotation digital computer (CORDIC) processor for efficient computation. In some embodiments, the magnitude/phase calculator 200 may be implemented using any other suitable approximation technique.

The preamble detector 230 is configured to detect a preamble encoded in the signal based on the magnitude samples 210. In some embodiments, the preamble is encoded as a pulsed continuous wave (CW) modulated signal and the preamble detector is configured to correlate, or time align match, pulses in the magnitude samples 210 to an expected preamble pulse sequence to detect the preamble. After detection of the preamble, an SPR window 260 can be generated, within which the SPR resides. The SPR window is a window in time (e.g., a number of samples) that begins at a known offset from the detected preamble and lasts for a known length, as specified for a given type of signal (e.g., an IFF Mode S signal).

The SPR detector 270 is configured to detect a synchronization phase reversal in the signal, from which a demodulation timing gate 275 may be generated for use by the DPSK demodulator 290. Detection of the SPR is based on the phase samples 220 within the SPR windows 260, as will be described below.

The phase corrector 280 is configured to compensate for phase wrapping of the phase samples to generate corrected phase samples 285 for use by the DPSK demodulator 290. As the signal phase approaches “critical points” of +/−pi radians, large shifts on the order of two pi radians may occur as the signal phase varies above and below that critical point boundary. These shifts will result in demodulation errors. Operation of the phase corrector 280 is described in greater detail below.

The DSPK demodulator 290 is configured to perform DPSK demodulation of the signal by integrating the corrected phase samples 285 over integration periods based on the demodulation timing gate 275, as will be described below.

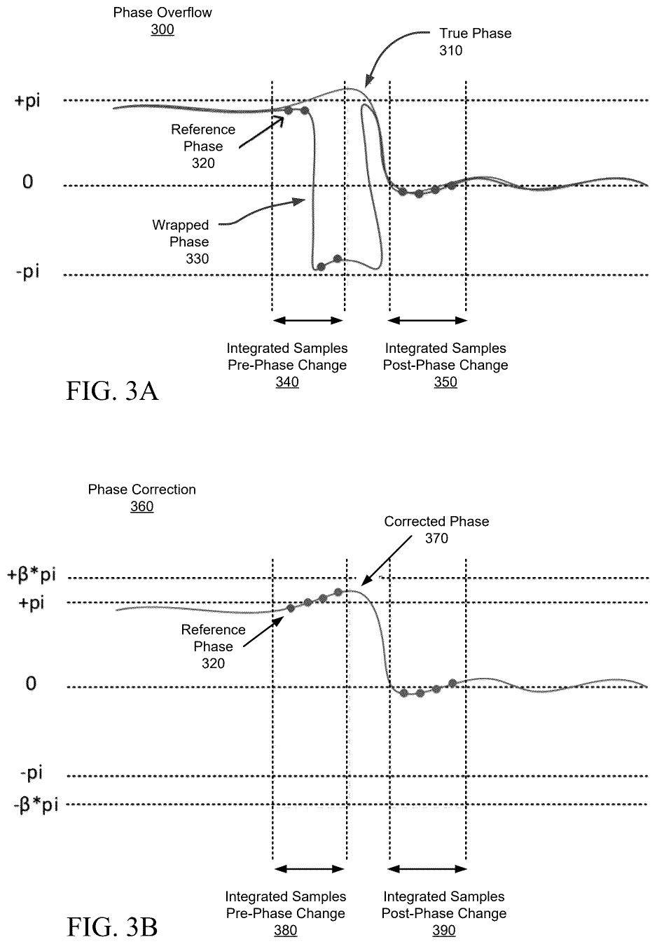

FIG. 3A illustrates phase overflow 300, in accordance with certain embodiments of the present disclosure. The true phase 310 of the signal is shown over a phase transition period where the true phase changes from +pi radians to zero radians. When the phase of the signal is near +pi radians, however, the magnitude/phase calculator 200 can generate a phase output 220 that overflows or wraps around to −pi radians, as illustrated by the wrapped phase 330. When the DPSK demodulator 290 integrates these phase samples in the pre-phase change region 340, the phase estimate will be incorrect, leading to demodulation errors. In contrast, integration of the phase samples in the post-phase change region 350, where the phase is close to zero radians in this example, will produce a correct phase estimate. As can be seen, errors may occur when the phase is close to +pi radians or −pi radians.

FIG. 3B illustrates phase correction 360, in accordance with certain embodiments of the present disclosure. A corrected phase 370 is shown, which is obtained in this example by adding two pi radians to the phase 220, when the phase samples are determined to be wrapped. Determination of phase wrapping is based on a comparison of the phase 220 to a reference phase value 320, as explained below in connection with the phase corrector 280. For example, in some embodiments, the corrected phase samples 370 are allowed to increase as high as beta times pi, when an overflow is detected relative to the reference phase value 320. The resulting corrected phase 370 allows for correct measurement of integrated phase, by the DPSK demodulator 290, both before 380 and after 390 the phase transition.

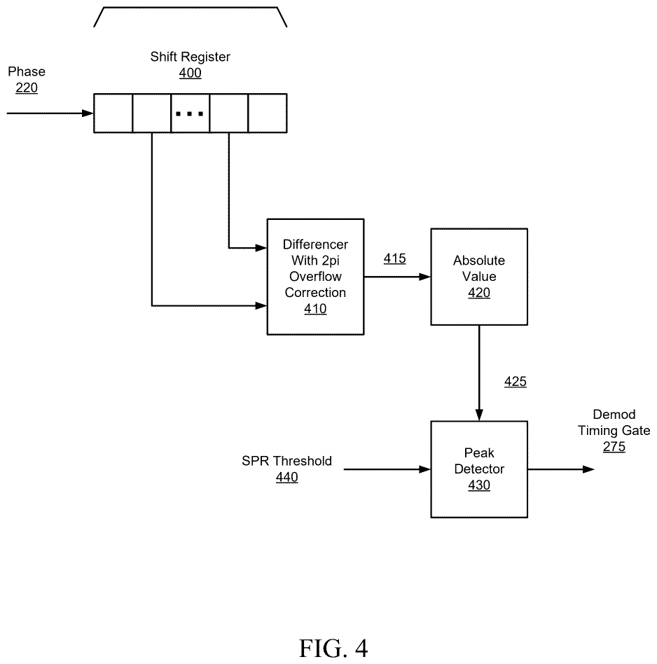

FIG. 4 is a block diagram of the SPR detector 270 of the demodulation system 150 of FIG. 2, configured in accordance with certain embodiments of the present disclosure. The SPR detector 270 is shown to include a shift register 400, a differencer circuit 410, an absolute value calculation circuit 420, and a peak detector 430.

For the case of an IFF Mode S waveform, an SPR occurs at a known time relative to the preamble detection and for a known duration. The SPR allows for a finer resolution of the integration gate timing used by the DPSK demodulator 290. At a high level of description, a relatively precise time reference for the SPR may be obtained by detecting a peak of the absolute value of the difference between two separated phase samples 220 provided from the magnitude/phase calculator 200. The integration gate timing derived from the SPR detection allows the DPSK demodulator 290 to reduce the edge effects of the phase transitions when integrating the phases.

In more detail, the shift register 400 is configured to store the incoming samples of phase 220 and is of a length large enough to store the SPR (e.g., greater than or equal to the SPR window).

The differencer circuit 410 is configured to calculate differences 415 between pairs of separated phase samples 220 within the SPR window 260. The differencer circuit also corrects for two pi overflows by adding or subtracting two pi if the difference lies outside of a two pi range (e.g., zero to two pi). The absolute value calculation circuit 420 is configured to calculate an absolute value 425 of the differences 415.

The peak detector 430 is configured to detect a peak of the absolute values 425, by comparison of the absolute values to an SPR threshold 440. The demodulation timing gate 275 is generated when the absolute value 425 of the phase difference exceeds the SPR threshold 440. In some embodiments, the SPR threshold 440 (and the amount of separation between samples read from the shift register) is empirically determined based on observed performance, as will be described in greater detail below.

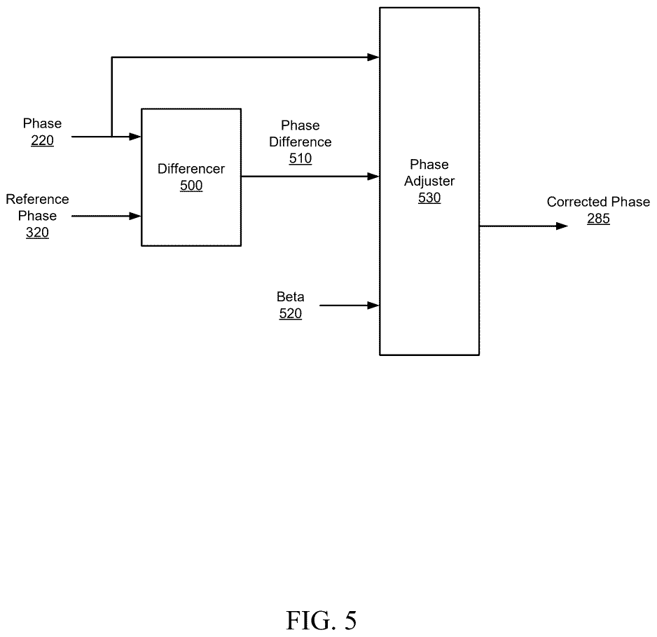

FIG. 5 is a block diagram of the phase corrector 280 of the demodulation system 150 of FIG. 2, configured in accordance with certain embodiments of the present disclosure. The phase corrector 280 is shown to include a differencing circuit 500 and a phase adjuster circuit 530.

The differencing circuit 500 is configured to calculate a difference 510 between the phase sample 220 and the reference phase value 320.

The phase adjuster circuit 530 is configured to subtract two pi radians from the phase sample 220, to generate the corrected phase 285, if the difference between the phase sample 220 and the reference phase value 320 is greater than beta times pi. Alternatively, if the difference between the phase sample 220 and the reference phase value 320 is less than negative beta times pi, the phase adjuster circuit 530 adds two pi radians to the phase sample 220 to generate the corrected phase 285. Otherwise, if the difference is within the range of negative beta times pi to positive beta times pi, correction is not needed, and the corrected phase 285 is set to the phase 220.

The reference phase value 320 is selected as a point leading up to the phase transition point, from which all successive phase samples can be compared. This allows for reliable integration of phase samples even at the unstable phase points of +/−pi. The values for the reference phase 320 and beta 520 may be selected empirically based on observations of the dynamics of the phase transition. For example, just prior to and after a phase transition, there will typically be an overshoot or undershoot on the phase value. The value of beta 520 may be set to provide sufficient accommodation for the overshoot or undershoot just prior to or just after the phase transition, to reduce the chance of errors occurring when the corrected phase samples are integrated.

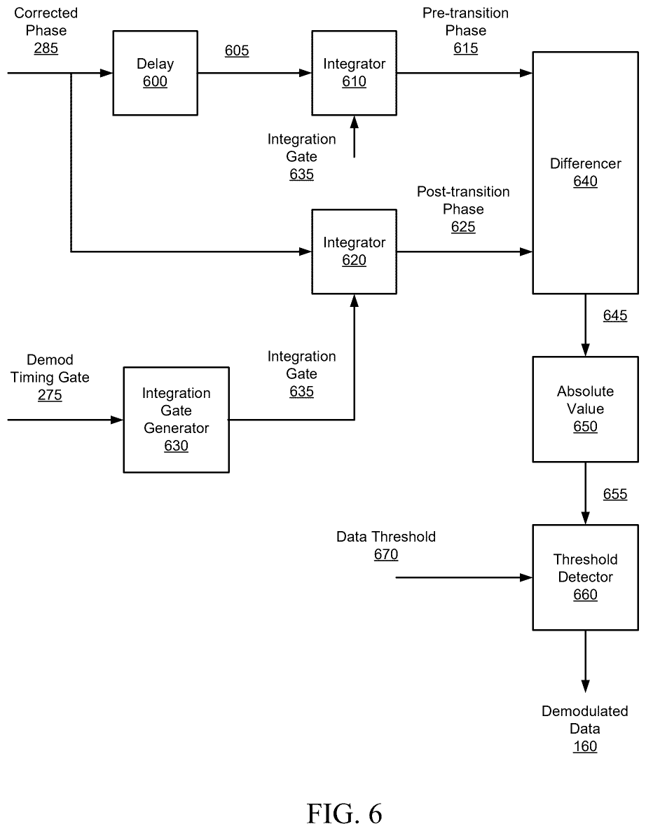

FIG. 6 is a block diagram of the DPSK demodulator 290 of the demodulation system 150 of FIG. 2, configured in accordance with certain embodiments of the present disclosure. The DPSK demodulator 290 is shown to include a delay 600, a first integrator 610, a second integrator 620, an integration gate generator 630, a differencer circuit 640, an absolute value calculation circuit 650, and a threshold detector 660.

The DPSK demodulator 290 is described in detail below, but at a high level, the demodulation process utilizes the timing reference of the SPR (the demodulation timing gate 275) to establish integration periods or gates 635 which define when and for how long the corrected phase samples 285 are integrated for each bit time. The integration gate 635 for each bit time, is centered so that edge effects, which are typically noisy, are not included in the integration. A programmable or dynamic data threshold 670 is utilized to determine the magnitude of the phase difference between successive bit times which indicates that a bit change has occurred.

In more detail, the delay 600 is configured to delay the corrected phase 285 by one sample. In some embodiments, the delay 600 may be implemented as a register or memory latch.

The integration gate generator 630 is configured to generate the integration gate 635 based on the demodulation timing gate 275 provided by the SPR detector 270.

The first integrator 610 is configured to integrate delayed corrected phase samples 605 over the integration periods, based on the integration gate 635, to generate a pre-transition phase 615. The second integrator 620 is configured to integrate the corrected phase samples 285 over the integration periods, based on the integration gate 635, to generate a post-transition phase 625.

The differencer circuit 640 is configured to calculate a difference 645 between the pre-transition phase 615 and the post-transition phase 625. The absolute value calculation circuit 650 is configured to calculate an absolute value 655 of the difference 645.

The threshold detector 660 is configured to compare the absolute value 655 of the phase difference to the threshold 670 to determine if a bit change has occurred in the demodulated signal 160. For example, when the absolute value 655 exceeds the data threshold 670, a bit of the demodulated signal data 160 toggles from zero to one, or from one to zero.

In some embodiments, the data threshold 670 (and the previously described SPR threshold 440) may be determined empirically, for example, by observing the error performance of the demodulation system 150 across the dynamic range of the signal and establishing thresholds (440 and 670) that meet the desired error performance (also known as a decode percentage). An empirical approach is typically employed due to the varying characteristics of the components in the input signal chain for a particular implementation. In some embodiments, the thresholds (440 and 670) may be dynamically set by observing the error rate of the system 150 over a learning period, with further continual adjustments possible after the initial learning period.

### Methodology

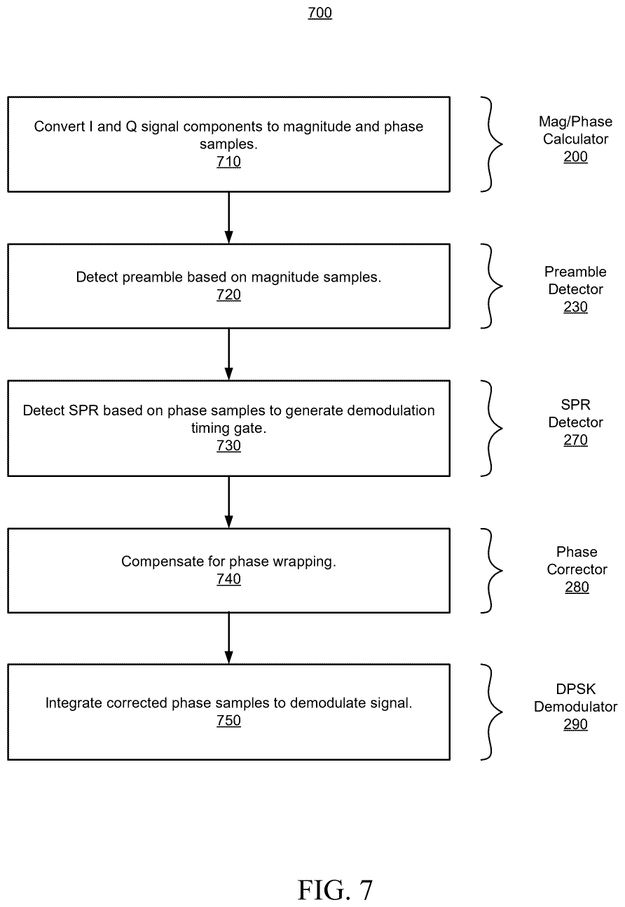

FIG. 7 is a flowchart illustrating a methodology 700 for demodulation of DPSK signals, in accordance with an embodiment of the present disclosure. As can be seen, example method 700 includes a number of phases and sub-processes, the sequence of which may vary from one embodiment to another. However, when considered in aggregate, these phases and sub-processes form a process for operation of the demodulation system 150, in accordance with certain of the embodiments disclosed herein, for example as illustrated in FIGS. 1-6, as described above. However other system architectures can be used in other embodiments, as will be apparent in light of this disclosure. To this end, the correlation of the various functions shown in FIG. 7 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 700 commences, at operation 710, by converting in-phase and quadrature phase components of a signal to magnitude samples and phase samples. In some embodiments, the CORDIC algorithm may be used to efficiently compute the magnitude and phase samples. In some embodiments, the signal is an IFF mode S signal.

At operation 720, a preamble is detected in the signal based on the magnitude samples. In some embodiments, the preamble is encoded as a pulsed CW modulated signal and the detection process includes correlating pulses in the magnitude samples to an expected preamble pulse sequence to detect the preamble.

At operation 730, an SPR is detected in the signal and used to generate a demodulation timing gate. The detection of the SPR is based on the phase samples and based on an SPR time offset relative to the detected preamble.

At operation 740, compensation for phase wrapping of the phase samples is performed to generate corrected phase samples. In some embodiments, phase wrap compensation includes: subtracting two pi radians from the phase sample, if a difference between the phase sample and a reference phase value is greater than beta times pi; and adding two pi radians to the phase sample if the difference between the phase sample and a reference phase value is less than negative beta times pi, wherein beta is a configurable scale factor.

At operation 750, the corrected phase samples are integrated over integration periods to perform DPSK demodulation of the signal. The integration periods are based on the demodulation timing gate.

In some embodiments, additional operations may be performed, as previously described in connection with the system. For example, the SPR detection may include calculating differences between pairs of the phase samples within a time window beginning at the SPR time offset relative to the detected preamble; calculating an absolute value of the differences; and detecting a peak of the absolute values to generate the demodulation timing gate.

In some embodiments, the DPSK demodulation may include integrating delayed corrected phase samples over the integration periods to generate a pre-transition phase; integrating the corrected phase samples over the integration periods to generate a post-transition phase; calculating a difference between the pre-transition phase and the post-transition phase; calculating an absolute value of the difference; and comparing the absolute value to a threshold to determine a bit change of the demodulated signal.

### Example System

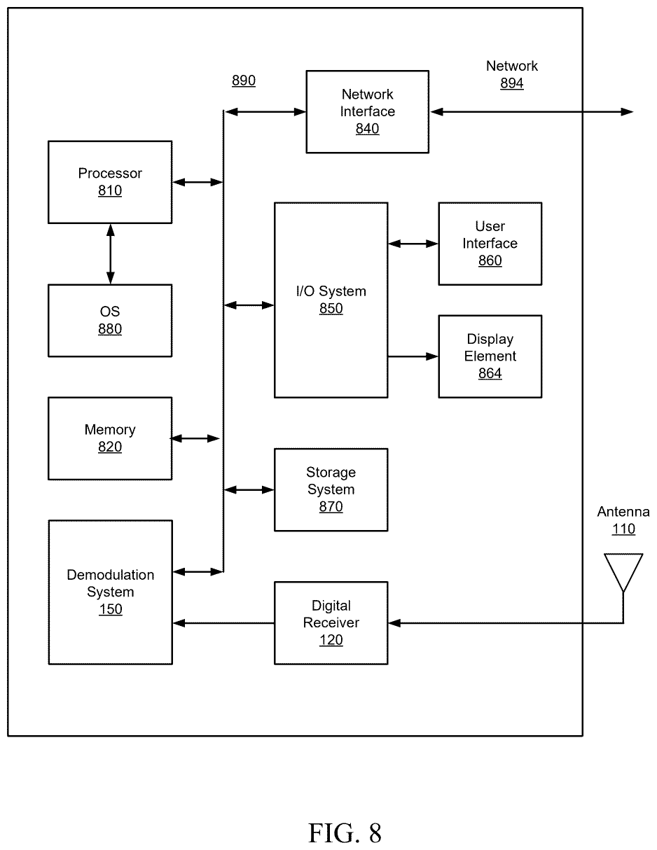

FIG. 8 is a block diagram of a processing platform 800 configured to perform DPSK signal demodulation, in accordance with an embodiment of the present disclosure. In some embodiments, platform 800, or portions thereof, may be hosted on, or otherwise be incorporated into the electronic and communications systems of an aircraft, ship, ground station, or man-portable system deployment.

In some embodiments, platform 800 may comprise any combination of a processor 810, memory 820, a network interface 840, an input/output (I/O) system 850, a user interface 860, a display element 864, a storage system 870, demodulation system 150, digital receiver 120, and antenna 110. As can be further seen, a bus and/or interconnect 890 is also provided to allow for communication between the various components listed above and/or other components not shown. Platform 800 can be coupled to a network 894 through network interface 840 to allow for communications with other computing devices, platforms, devices to be controlled, or other resources. Other componentry and functionality not reflected in the block diagram of FIG. 8 will be apparent in light of this disclosure, and it will be appreciated that other embodiments are not limited to any particular hardware configuration.

Processor 810 can be any suitable processor, and may include one or more coprocessors or controllers, such as an audio processor, a graphics processing unit, or hardware accelerator, to assist in the execution of mission software and/or any control and processing operations associated with platform 800, including application processors that make use of the demodulated data provided by demodulation system 150. In some embodiments, the processor 810 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 810 may be implemented as a complex instruction set computer (CISC) or a reduced instruction set computer (RISC) processor. In some embodiments, processor 810 may be configured as an x86 instruction set compatible processor.

Memory 820 can be implemented using any suitable type of digital storage including, for example, flash memory and/or random access memory (RAM). In some embodiments, the memory 820 may include various layers of memory hierarchy and/or memory caches as are known to those of skill in the art. Memory 820 may be implemented as a volatile memory device such as, but not limited to, a RAM, dynamic RAM (DRAM), or static RAM (SRAM) device. Storage system 870 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 810 may be configured to execute an Operating System (OS) 880 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 800, and therefore may also be implemented using any suitable existing or subsequently-developed platform.

Network interface circuit 840 can be any appropriate network chip or chipset which allows for wired and/or wireless connection between other components of platform 800 and/or network 894, thereby enabling platform 800 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 850 may be configured to interface between various I/O devices and other components of platform 800. I/O devices may include, but not be limited to, user interface 860 and display element 864. User interface 860 may include devices (not shown) such as a touchpad, cockpit display unit, keyboard, and mouse, etc., for example, to allow the user to control the system. Display element 864 may be configured to display information to a user. I/O system 850 may include a graphics subsystem configured to perform processing of images for rendering on the display element 864. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 810 or any chipset of platform 800.

It will be appreciated that in some embodiments, the various components of platform 800 may be combined or integrated in a system-on-a-chip (SoC) architecture. In some embodiments, the components may be hardware components, firmware components, software components or any suitable combination of hardware, firmware, or software.

Demodulation system 150 is configured to perform DPSK demodulation of signals received through Digital receiver 120, as described previously. Demodulation system 150 may include any or all of the circuits/components illustrated in FIGS. 2 and 4-6, as described above. These components can be implemented or otherwise used in conjunction with a variety of suitable software and/or hardware that is coupled to or that otherwise forms a part of platform 800. These components can additionally or alternatively be implemented or otherwise used in conjunction with user I/O devices that are capable of providing information to, and receiving information and commands from, a user.

In various embodiments, platform 800 may be implemented as a wireless system, a wired system, or a combination of both. When implemented as a wireless system, platform 800 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 800 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 894. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 800 may comprise additional, fewer, or alternative subcomponents as compared to those included in the example embodiment of FIG. 8.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a system for demodulating a signal, the system comprising: a magnitude/phase calculator configured to convert an in-phase component of a signal and a quadrature phase component of the signal to magnitude samples and phase samples; a synchronization phase reversal (SPR) detector configured to detect an SPR in the signal to generate a demodulation timing gate, the detection of the SPR based on the phase samples and based on an SPR time offset relative to a preamble in the signal; a phase correction circuit configured to compensate for phase wrapping of the phase samples to generate corrected phase samples for demodulation; and a differential phase shift keying (DPSK) demodulator configured to integrate the corrected phase samples over integration periods to demodulate the signal, the integration periods based on the demodulation timing gate.

Example 2 includes the system of Example 1, wherein the phase correction circuit is configured to subtract two pi radians from the phase sample, if a difference between the phase sample and a reference phase value is greater than beta times pi, and add two pi radians to the phase sample if the difference between the phase sample and the reference phase value is less than negative beta times pi, wherein beta is a configurable scale factor.

Example 3 includes the system of Examples 1 or 2, wherein the SPR detector comprises: a differencing circuit configured to calculate differences between pairs of the phase samples within a time window beginning at the SPR time offset relative to the preamble; an absolute value circuit configured to calculate an absolute value of the differences; and a peak detector configured to detect a peak of the absolute values to generate the demodulation timing gate.

Example 4 includes the system of any of Examples 1-3, wherein the DPSK demodulator comprises: a first integrator configured to integrate delayed corrected phase samples over the integration periods to generate a pre-transition phase; a second integrator configured to integrate the corrected phase samples over the integration periods to generate a post-transition phase; a differencing circuit configured to calculate a difference between the pre-transition phase and the post-transition phase; an absolute value circuit configured to calculate an absolute value of the difference; and a threshold detector configured to compare the absolute value to a threshold to determine a bit change of the demodulated signal.

Example 5 includes the system of any of Examples 1-4, wherein the magnitude/phase calculator is configured to generate the magnitude samples and the phase samples using a coordinate rotation digital computer (CORDIC) algorithm.

Example 6 includes the system of any of Examples 1-5, comprising a preamble detector configured to detect the preamble in the signal, wherein the preamble is encoded as a pulsed continuous wave (CW) modulated signal and the preamble detector is configured to correlate pulses in the magnitude samples to an expected preamble pulse sequence to detect the preamble.

Example 7 includes the system of any of Examples 1-6, wherein the signal is an Identification Friend or Foe (IFF) mode Select (mode S) signal.

Example 8 is a computer program product including one or more non-transitory machine-readable mediums encoded with instructions that when executed by one or more processors cause a process to be carried out for signal demodulation, the process comprising: receiving a signal at an antenna; converting an in-phase component of the signal and a quadrature phase component of the signal to magnitude samples and phase samples; detecting a preamble in the signal based on the magnitude samples; detecting a synchronization phase reversal (SPR) in the signal to generate a demodulation timing gate, the detection of the SPR based on the phase samples and based on an SPR time offset relative to the detected preamble; compensating for phase wrapping of the phase samples to generate corrected phase samples for demodulation; and integrating the corrected phase samples over integration periods to perform differential phase shift keying (DPSK) demodulation of the signal, the integration periods based on the demodulation timing gate.

Example 9 includes the computer program product of Example 8, wherein compensating for phase wrapping of the phase samples comprises: subtracting two pi radians from the phase sample, if a difference between the phase sample and a reference phase value is greater than beta times pi; and adding two pi radians to the phase sample if the difference between the phase sample and the reference phase value is less than negative beta times pi, wherein beta is a configurable scale factor.

Example 10 includes the computer program product of Examples 8 or 9, wherein the process comprises: calculating differences between pairs of the phase samples within a time window beginning at the SPR time offset relative to the detected preamble; calculating an absolute value of the differences; and detecting a peak of the absolute values to generate the demodulation timing gate.

Example 11 includes the computer program product of any of Examples 8-10, wherein the process comprises: integrating delayed corrected phase samples over the integration periods to generate a pre-transition phase; integrating the corrected phase samples over the integration periods to generate a post-transition phase; calculating a difference between the pre-transition phase and the post-transition phase; calculating an absolute value of the difference; and comparing the absolute value to a threshold to determine a bit change of the demodulated signal.

Example 12 includes the computer program product of any of Examples 8-11, wherein the process comprises generating the magnitude samples and the phase samples using a coordinate rotation digital computer (CORDIC) algorithm.

Example 13 includes the computer program product of any of Examples 8-12, wherein the preamble is encoded as a pulsed continuous wave (CW) modulated signal and the process comprises correlating pulses in the magnitude samples to an expected preamble pulse sequence to detect the preamble.

Example 14 includes the computer program product of any of Examples 8-13, wherein the signal is an Identification Friend or Foe (IFF) mode Select (mode S) signal.

Example 15 is a method for signal demodulation, the method comprising: receiving a signal at an antenna; converting an in-phase component of the signal and a quadrature phase component of the signal to magnitude samples and phase samples; detecting a preamble in the signal based on the magnitude samples; detecting a synchronization phase reversal (SPR) in the signal to generate a demodulation timing gate, the detection of the SPR based on the phase samples and based on an SPR time offset relative to the detected preamble; compensating for phase wrapping of the phase samples to generate corrected phase samples for demodulation; and integrating the corrected phase samples over integration periods to perform differential phase shift keying (DPSK) demodulation of the signal, the integration periods based on the demodulation timing gate.

Example 16 includes the method of Example 15, wherein compensating for phase wrapping of the phase samples comprises: subtracting two pi radians from the phase sample, if a difference between the phase sample and a reference phase value is greater than beta times pi; and adding two pi radians to the phase sample if the difference between the phase sample and the reference phase value is less than negative beta times pi, wherein beta is a configurable scale factor.

Example 17 includes the method of Examples 15 or 16, comprising: calculating differences between pairs of the phase samples within a time window beginning at the SPR time offset relative to the detected preamble; calculating an absolute value of the differences; and detecting a peak of the absolute values to generate the demodulation timing gate.

Example 18 includes the method of any of Examples 15-17, comprising: integrating delayed corrected phase samples over the integration periods to generate a pre-transition phase; integrating the corrected phase samples over the integration periods to generate a post-transition phase; calculating a difference between the pre-transition phase and the post-transition phase; calculating an absolute value of the difference; and comparing the absolute value to a threshold to determine a bit change of the demodulated signal.

Example 19 includes the method of any of Examples 15-18, wherein the preamble is encoded as a pulsed continuous wave (CW) modulated signal and the method comprises correlating pulses in the magnitude samples to an expected preamble pulse sequence to detect the preamble.

Example 20 includes the method of any of Examples 15-19, wherein the signal is an Identification Friend or Foe (IFF) mode Select (mode S) signal.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A system for demodulating a signal, the system comprising:
a magnitude/phase calculator configured to convert an in-phase component of a signal and a quadrature phase component of the signal to magnitude samples and phase samples;
a synchronization phase reversal (SPR) detector configured to detect an SPR in the signal to generate a demodulation timing gate, the detection of the SPR based on the phase samples and based on an SPR time offset relative to a preamble in the signal;
a phase correction circuit configured to compensate for phase wrapping of the phase samples to generate corrected phase samples for demodulation; and
a differential phase shift keying (DPSK) demodulator configured to integrate the corrected phase samples over integration periods to demodulate the signal, the integration periods based on the demodulation timing gate.

2. The system of claim 1, wherein the phase correction circuit is configured to subtract two pi radians from the phase sample, if a difference between the phase sample and a reference phase value is greater than beta times pi, and add two pi radians to the phase sample if the difference between the phase sample and the reference phase value is less than negative beta times pi, wherein beta is a configurable scale factor.

3. The system of claim 1, wherein the SPR detector comprises:
a differencing circuit configured to calculate differences between pairs of the phase samples within a time window beginning at the SPR time offset relative to the preamble;
an absolute value circuit configured to calculate an absolute value of the differences; and
a peak detector configured to detect a peak of the absolute values to generate the demodulation timing gate.

4. The system of claim 1, wherein the DPSK demodulator comprises:
a first integrator configured to integrate delayed corrected phase samples over the integration periods to generate a pre-transition phase;
a second integrator configured to integrate the corrected phase samples over the integration periods to generate a post-transition phase;
a differencing circuit configured to calculate a difference between the pre-transition phase and the post-transition phase;
an absolute value circuit configured to calculate an absolute value of the difference; and
a threshold detector configured to compare the absolute value to a threshold to determine a bit change of the demodulated signal.

5. The system of claim 1, wherein the magnitude/phase calculator is configured to generate the magnitude samples and the phase samples using a coordinate rotation digital computer (CORDIC) algorithm.

6. The system of claim 1, comprising a preamble detector configured to detect the preamble in the signal, wherein the preamble is encoded as a pulsed continuous wave (CW) modulated signal and the preamble detector is configured to correlate pulses in the magnitude samples to an expected preamble pulse sequence to detect the preamble.

7. The system of claim 1, wherein the signal is an Identification Friend or Foe (IFF) mode Select (mode S) signal.

8. A computer program product including one or more non-transitory machine-readable mediums encoded with instructions that when executed by one or more processors cause a process to be carried out for signal demodulation, the process comprising:
receiving a signal at an antenna;
converting an in-phase component of the signal and a quadrature phase component of the signal to magnitude samples and phase samples;
detecting a preamble in the signal based on the magnitude samples;
detecting a synchronization phase reversal (SPR) in the signal to generate a demodulation timing gate, the detection of the SPR based on the phase samples and based on an SPR time offset relative to the detected preamble;
compensating for phase wrapping of the phase samples to generate corrected phase samples for demodulation; and
integrating the corrected phase samples over integration periods to perform differential phase shift keying (DPSK) demodulation of the signal, the integration periods based on the demodulation timing gate.

9. The computer program product of claim 8, wherein compensating for phase wrapping of the phase samples comprises:
subtracting two pi radians from the phase sample, if a difference between the phase sample and a reference phase value is greater than beta times pi; and
adding two pi radians to the phase sample if the difference between the phase sample and the reference phase value is less than negative beta times pi, wherein beta is a configurable scale factor.

10. The computer program product of claim 8, wherein the process comprises:
calculating differences between pairs of the phase samples within a time window beginning at the SPR time offset relative to the detected preamble;
calculating an absolute value of the differences; and
detecting a peak of the absolute values to generate the demodulation timing gate.

11. The computer program product of claim 8, wherein the process comprises:
integrating delayed corrected phase samples over the integration periods to generate a pre-transition phase;
integrating the corrected phase samples over the integration periods to generate a post-transition phase;
calculating a difference between the pre-transition phase and the post-transition phase;
calculating an absolute value of the difference; and
comparing the absolute value to a threshold to determine a bit change of the demodulated signal.

12. The computer program product of claim 8, wherein the process comprises generating the magnitude samples and the phase samples using a coordinate rotation digital computer (CORDIC) algorithm.

13. The computer program product of claim 8, wherein the preamble is encoded as a pulsed continuous wave (CW) modulated signal and the process comprises correlating pulses in the magnitude samples to an expected preamble pulse sequence to detect the preamble.

14. The computer program product of claim 8, wherein the signal is an Identification Friend or Foe (IFF) mode Select (mode S) signal.

15. A method for signal demodulation, the method comprising:
receiving a signal at an antenna;
converting an in-phase component of the signal and a quadrature phase component of the signal to magnitude samples and phase samples;
detecting a preamble in the signal based on the magnitude samples;
detecting a synchronization phase reversal (SPR) in the signal to generate a demodulation timing gate, the detection of the SPR based on the phase samples and based on an SPR time offset relative to the detected preamble;
compensating for phase wrapping of the phase samples to generate corrected phase samples for demodulation; and
integrating the corrected phase samples over integration periods to perform differential phase shift keying (DPSK) demodulation of the signal, the integration periods based on the demodulation timing gate.

16. The method of claim 15, wherein compensating for phase wrapping of the phase samples comprises:
subtracting two pi radians from the phase sample, if a difference between the phase sample and a reference phase value is greater than beta times pi; and
adding two pi radians to the phase sample if the difference between the phase sample and the reference phase value is less than negative beta times pi, wherein beta is a configurable scale factor.

17. The method of claim 15, comprising:
calculating differences between pairs of the phase samples within a time window beginning at the SPR time offset relative to the detected preamble;
calculating an absolute value of the differences; and
detecting a peak of the absolute values to generate the demodulation timing gate.

18. The method of claim 15, comprising:
integrating delayed corrected phase samples over the integration periods to generate a pre-transition phase;
integrating the corrected phase samples over the integration periods to generate a post-transition phase;
calculating a difference between the pre-transition phase and the post-transition phase;
calculating an absolute value of the difference; and
comparing the absolute value to a threshold to determine a bit change of the demodulated signal.

19. The method of claim 15, wherein the preamble is encoded as a pulsed continuous wave (CW) modulated signal and the method comprises correlating pulses in the magnitude samples to an expected preamble pulse sequence to detect the preamble.

20. The method of claim 15, wherein the signal is an Identification Friend or Foe (IFF) mode Select (mode S) signal.
